(19) United States
(12) Patent Application Publication
(10) Pub. No.: US 2021/0296743 A1
(43) Pub. Date: Sep. 23, 2021

(54) SECONDARY BATTERY USING BIPOLAR ELECTRODE

(71) Applicant: HONDA MOTOR CO., LTD., Tokyo (JP)

(72) Inventors: Shigemitsu AKUTSU, Saitama (JP); Shinji FUJIMOTO, Saitama (JP)

(21) Appl. No.: 17/191,724

(22) Filed: Mar. 4, 2021

(30) Foreign Application Priority Data
Mar. 18, 2020 (JP) 2020-047549

(51) Int. Cl. H01M 50/54; H01M 4/13; H01M 50/172; H01M 50/124; H01M 10/0585

(52) U.S. Cl. CPC H01M 50/54; H01M 4/13; H01M 2004/029; H01M 50/124; H01M 10/0585; H01M 50/172

(57) ABSTRACT

Provided is a secondary battery made using a bipolar electrode for which productivity is not inhibited for reasons such as requiring an electrode welding method differing from a normal electrode. Provided are a partial power generation element configured by a single laminate body in which a bipolar electrode having a positive electrode of polarizable electrode formed on one surface and a negative electrode of the polarizable electrode formed on the other surface of one sheet-like collector, laminated on at least one surface side of a solid electrolyte later, or configured by a multi-layer laminate body in which a plurality of the single laminate bodies are laminated; and normal electrodes of a form laminated directly or via the solid electrolyte layer on the one surface side and other surface side of the partial power generation element, in which poles of the same polarity are formed on the same surface of the one sheet-like collector.

This application is based on and claims the benefit of priority from Japanese Patent Application No. 2020-047549, filed on 18 Mar. 2020, the content of which is incorporated herein by reference.

### BACKGROUND OF THE INVENTION

### Field of the Invention

The present invention relates to a secondary battery made using a bipolar electrode.

### Related Art

In recent years, various secondary batteries made using bipolar electrodes have been proposed (for example, refer to Patent Document 1, Patent Document 2, Patent Document 3).

Patent Document 1: Japanese Patent No. 4501905

Patent Document 2: Japanese Patent No. 4300310

Patent Document 3: U.S. Pat. No. 9,972,860

### SUMMARY OF THE INVENTION

In a secondary battery made using a bipolar electrode, it assumes a configuration laminating a plurality of single laminate bodies in which a bipolar electrode is laminated on the side of at least one surface of a solid electrolyte layer for obtaining the required voltage between output terminals, so as to make a serial connection. However, for reasons such as requiring an electrode welding method different from a normal electrode, the bipolar electrode leaves a problem in the point of productivity.

The present invention has been made taking account of the above-mentioned situation, and has an object of providing a secondary battery made using a bipolar electrode superior in productivity.

According to a first aspect of the present invention, a secondary battery comprising a bipolar electrode includes: a partial power generation element which is configured by a single laminate body, in which bipolar electrode (for example, the bipolar electrode 17 described later) having a positive electrode (for example, the positive electrode mixture slurry 19 described later) of a polarizable electrode formed on one surface and a negative electrode (for example, the negative electrode mixture slurry 20 described later) of the polarizable electrode formed on the other surface of one sheet-like collector (for example, the sheet-like collector 18 described later), is laminated on at least one surface side of a solid electrolyte layer (for example, the solid electrolyte layer 2 described later), or is configured by a multi-layer laminate body in which a plurality of the single laminate bodies is laminated; and

a normal electrode (for example, the positive electrode normal electrode 3, negative electrode normal electrode 4 described later) of a form laminated directly or via the solid electrolyte layer on the one surface side and the other surface side of the partial power generation element, and in which poles of the same polarity are formed on both surfaces of one sheet-like collector.

According to a second aspect of the present invention, in the secondary battery comprising the bipolar electrode as described in the first aspect, the normal electrode is either a positive electrode normal electrode (for example, the positive electrode normal electrode 3 described later) of a form laminated on one surface side of the partial power generation element and having a pole of positive polarity formed on both surfaces of one sheet-like collector, or a negative electrode normal electrode (for example, the negative electrode normal electrode 4 described later) laminated on the other surface side of the partial power generation element and having a pole of negative polarity formed on both surfaces of the one sheet-like collector.

According to a third aspect of the present invention, in the secondary battery comprising the bipolar electrode as described in the second aspect, the partial power generation element configures a serial partial power generation element (for example, the serial partial power generation element 26, 26a, 26b, 26c, 26d described later) in which a single laminate body (for example, the single laminate body 25 described later) configuring the multi-layer laminate body is laminated in a direction of polarity configuring a serial connection, between the positive electrode normal electrode and the negative electrode normal electrode.

According to a fourth aspect of the present invention, in the secondary battery comprising the bipolar electrode as described in the third aspect, the secondary battery configures a parallel connection body of a first form (for example, the parallel connection body of a first form 27, 27a, 27b, 27d described later) in which the serial partial power generation element is joined, with one of the positive electrode normal electrodes as a positive electrode collector electrode (for example, the positive electrode collector electrode 5 described later), between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrodes.

According to a fifth aspect of the present invention, in the secondary battery comprising the bipolar electrode as described in the third aspect, the secondary battery configures a parallel connection body of a second form (for example, the parallel connection body of a second form 28 described later) in which the serial partial power generation element is joined, with one of the negative electrode normal electrodes as a negative electrode collector electrode (for example, the negative electrode sheet-like collector 7 described later), between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes.

According to a sixth aspect of the present invention, in the secondary battery comprising the bipolar electrode as described in the third aspect, a parallel connection body of a first form (for example, the parallel connection body of a first form 27, 27a, 27b, 27c, 27d described later) in which the serial partial power generation element is joined, with one of the positive electrode normal electrodes as a positive electrode collector electrode (for example, the positive electrode collector electrode 5 described later), between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrodes, and

a parallel connection body of a second form (for example, the parallel connection body of a second form 28 described later) in which the serial partial power generation element is joined, with one of the negative electrode normal electrodes as a negative electrode collector electrode (for example, the negative electrode sheet-like collector 7 described later), between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes, configure

a composite parallel connection body (for example, the composite parallel connection body 29, 29a, 29b, 29c, 29d, 29e described later) by sharing the serial partial power generation element between the positive electrode collector electrode or the negative electrode collector electrode, and one of the negative electrode normal electrode or the positive electrode normal electrode.

According to a seventh aspect of the present invention, in the secondary battery comprising the bipolar electrode as described in the sixth aspect, the composite parallel connection body has the negative electrode normal electrode located at both outermost ends in a connection direction thereof.

According to an eighth aspect of the present invention, in the secondary battery comprising the bipolar electrode as described in the sixth aspect, the composite parallel connection body has the positive electrode normal electrode located at both outermost ends in a connection direction thereof.

According to a ninth aspect of the present invention, in the secondary battery comprising the bipolar electrode as described in any one of the sixth to eighth aspects, the composite parallel connection body provides a connection conductor to each of the positive collector electrode and the negative collector electrode, and provides a positive electrode tab (for example, the positive electrode tab 10 described later) and a negative electrode tab (for example, the negative electrode tab 11 described later) for supplying output power to outside collectively to each of the connection conductors of positive polarity and negative polarity.

According to a tenth aspect of the present invention, the secondary battery comprising the bipolar electrode as described in the ninth aspect, further includes an outer packaging (for example, the outer packaging 12 described later) of laminate material enveloping the composite parallel connection body and the connection conductors of positive polarity and negative polarity, wherein a part of the positive electrode tab and the negative electrode tab are led to outside from the outer packaging.

The secondary battery made using the bipolar electrode of the first aspect, one surface side and the other surface side of a partial power generation element, which is a single laminate body in which a bipolar electrode is laminated, or a multi-layer laminate body in which a plurality of the single laminate bodies is laminated, is a normal electrode. For this reason, technology compatible with bipolar electrodes is not necessitated in the conductor connection for leading secondary battery output to outside, and thus can be handled by conventional technology. For this reason, production is simple.

With the secondary battery comprising the bipolar electrode as described in the second aspect, the normal electrode is either a positive electrode normal electrode (for example, the positive electrode normal electrode 3 described later) of a form laminated on one surface side of the partial power generation element and having a pole of positive polarity formed on both surfaces of one sheet-like collector, or a negative electrode normal electrode (for example, the negative electrode normal electrode 4 described later) laminated on the other surface side of the partial power generation element and having a pole of negative polarity formed on both surfaces of the one sheet-like collector. For this reason, new technology for handling bipolar electrodes is not necessitated in the conductor connection for leading secondary battery output to outside, and thus can be handled by conventional technology. For this reason, production is simple.

With the secondary battery comprising the bipolar electrode as described in the third aspect, the partial power generation elements configure a serial partial power generation element, which is a serial connection body of a single laminate body configurating a multi-layer laminate body between the positive electrode normal electrode and the negative electrode normal electrode. For this reason, it is possible to configure a serial connection body by laminating so as to directly contact without going through other conductors, and possible to take full advantage of using bipolar electrode for which the internal resistance decreases.

With the secondary battery comprising the bipolar electrode as described in the fourth aspect, it is possible to collect the connecting parts of the positive electrode in the parallel connection body of the first form at the positive electrode collector electrode, which is one positive electrode normal electrode. For this reason, it is possible to reduce the number of connection conductors for configuring a parallel connection body.

With the secondary battery comprising the bipolar electrode as described in the fifth aspect, it is possible to collect the connecting parts of the negative electrode in the parallel connection body of the second form at the negative electrode collector electrode, which is one negative electrode normal electrode. For this reason, it is possible to reduce the number of connection conductors for configuring a parallel connection body.

With the secondary battery comprising the bipolar electrode as described in the sixth aspect, it is possible to decrease the number of connection conductors in each parallel connection body constituting the composite parallel connection body.

With the secondary battery comprising the bipolar electrode as described in the seventh aspect, the composite parallel connection body has the negative electrode normal electrode located at both outermost ends in a connection direction thereof. For this reason, even without interposing a separate insulating body between the outer packaging, since the potential at the site at which the composite parallel connection body contacts the inner surface of the outer packaging is the same potential at the negative electrode, the safety is secured.

With the secondary battery comprising the bipolar electrode as described in the eighth aspect, the composite parallel connection body has the positive electrode normal electrode located at both outermost ends in a connection direction thereof. For this reason, even without interposing a separate insulating body between the outer packaging, since the potential at the site at which the composite parallel connection body contacts the inner surface of the outer packaging is the same potential at the positive electrode, the safety is secured.

With the secondary battery comprising the bipolar electrode as described in the ninth aspect, the composite parallel connection body provides a connection conductor to each of the positive collector electrode and the negative collector electrode, and provides a positive electrode tab and a negative electrode tab for supplying output power to outside collectively to each of the connection conductors of positive polarity and negative polarity. For this reason, a battery pack which is compact overall and having good usability is provided.

The secondary battery comprising the bipolar electrode as described in the tenth aspect provides an outer packaging of laminate material enveloping the composite parallel connection body and the connection conductors of positive polarity and negative polarity, in which a part of the positive electrode tab and the negative electrode tab are led to outside from the outer packaging. For this reason, a compact battery pack suited to a configuration as an all solid-state battery is provided.

### BRIEF DESCRIPTION OF THE DRAWINGS

FIG. 1 is a cross-sectional view representing a bipolar electrode applied to an embodiment of the present invention;

FIG. 2 is a theoretical configurational diagram of a secondary battery made using the bipolar electrode of the present invention;

FIG. 3 is a view for explaining the occurrence status of a potential difference between both positive/negative electrodes of a laminate body of two layers made by laminating two single laminate bodies in series, in the embodiment of the present invention;

FIG. 4 is a view for explaining the occurrence status of a potential difference between both positive/negative electrodes of a laminate body of three layers made by laminating three single laminate bodies in series, in the embodiment of the present invention;

FIG. 5 is a view for explaining the occurrence status of a potential difference between both positive/negative electrodes of a laminate body of four layers made by laminating four single laminate bodies in series, in the embodiment of the present invention;

FIG. 6 is a view for explaining the occurrence status of a potential difference between both positive/negative electrodes of a laminate body of six layers made by laminating six single laminate bodies in series, in the embodiment of the present invention;

FIG. 7 is a view for explaining a configuration connecting in parallel two laminate bodies of two layers made by laminating two single laminate bodies in series, and an occurrence situation of a potential difference between both positive/negative electrodes for every laminate body of two layers, in an embodiment of the present invention;

FIG. 8 is a view for explaining a configuration connecting in parallel two laminate bodies of three layers made by laminating in series three single laminate bodies, and an occurrence situation of the potential difference between both positive/negative electrodes for every laminate body of three layers, in an embodiment of the present invention;

FIG. 9 is a view for explaining a configuration connecting in parallel two laminate bodies of six layers made by laminating in series six single laminate bodies, and an occurrence situation of the potential difference between both positive/negative electrodes for every laminate body of six layers, in an embodiment of the present invention;

FIG. 10 is a view for explaining a configuration connecting in parallel three laminate bodies of six layers made by laminating in series six single laminate bodies, and an occurrence situation of the potential difference between both positive/negative electrodes for every laminate body of six layers, in an embodiment of the present invention;

FIG. 11 is a view for explaining a configuration connecting in parallel four laminate bodies of six layers made by laminating in series six single laminate bodies, and an occurrence situation of the potential difference between both positive/negative electrodes for every laminate body of six layers, in an embodiment of the present invention;

FIG. 12 is a view for explaining a configuration connecting in parallel four laminate bodies of twelve layers made by laminating in series twelve single laminate bodies, and an occurrence situation of the potential difference between both positive/negative electrodes for every laminate body of twelve layers, in an embodiment of the present invention, and the form of wiring to the positive electrode terminal collector electrode plate and negative electrode terminal collector electrode plate;

FIG. 13 is a view for explaining a configuration connecting in parallel eight laminate bodies of six layers made by laminating in series six single laminate bodies, and an occurrence situation of the potential difference between both positive/negative electrodes for every laminate body of six layers, in an embodiment of the present invention, and the form of wiring to the positive electrode terminal collector electrode plate and negative electrode terminal collector electrode plate;

FIG. 14 is a view for explaining a configuration connecting in parallel twelve laminate bodies of four layers made by laminating in series four single laminate bodies, and an occurrence situation of the potential difference between both positive/negative electrodes for every laminate body of four layers, in an embodiment of the present invention, and the form of wiring to the positive electrode terminal collector electrode plate and negative electrode terminal collector electrode plate;

FIG. 15 is an exploded conceptual view for explaining the physical configuration of a plurality of layers of laminate body made by laminating in series a plurality of single laminate bodies, in the embodiment of the present invention;

FIG. 16 is a conceptual view after lamination of the laminate bodies in FIG. 15;

FIG. 17 is a view showing a battery pack storing the laminate body of FIG. 16 in an outer packaging;

FIG. 18 is a projection drawing of the laminate of the battery pack of FIG. 17 in a lamination direction;

FIG. 19 is a view showing a solid-state battery configured by normal electrodes and solid electrolyte;

FIG. 20 is a view for explaining the form of wiring to the positive electrode terminal collector electrode plate and the negative electrode terminal collector electrode plate, in a power generation unit made by connecting in parallel a plurality of solid-state batteries of FIG. 19; and

FIG. 21 is a view for explaining the form of wiring to the positive electrode terminal collector electrode plate and the negative electrode terminal collector electrode plate, as well as a midpoint potential connection part, in a power generation unit made by connecting in series a plurality of partial power generation units made by connecting in parallel a plurality of solid-state batteries of FIG. 19.

### DETAILED DESCRIPTION OF THE INVENTION

Herein, an embodiment of the present invention will be explained while referencing the drawings. A secondary battery made using a bipolar electrode as an embodiment of the present invention is configured to include a bipolar electrode and a normal electrode. FIG. 19 is a view showing a solid-state battery 1 configured by normal electrodes and solid electrolyte. This solid-state battery 1 is configured by a positive electrode normal electrode 3 being laminated on the side of one surface and a negative electrode normal electrode 4 being laminated on the side of another surface of a plate-like solid electrolyte layer 2.

The positive electrode normal electrode 3 is a normal electrode of a form formed as a pole of positive polarity by coating a positive electrode mixture 6 containing a positive electrode active material such as lithium cobalt oxide and lithium phosphate, and further a conductive aid and binder, on both sides of one positive electrode sheet-like collector 5, which is a current collector foil such as aluminum.

The negative electrode normal electrode 4 is a normal electrode of a form formed as a pole of positive polarity by coating a negative electrode mixture 8 containing a positive electrode active material such as graphite and lithium titanate, and further a binder, on both sides of one negative electrode sheet-like collector 7, which is a current collector foil such as copper.

The solid-state battery 1 generates electromotive force E between the positive electrode sheet-like collector 5 and negative electrode sheet-like collector 7. The solid-state battery 1 is a battery configuring one power generation element in which a plurality of serial connection bodies connected in series electrically with the same type of solid-state batteries and producing a predetermined electromotive force is connected in parallel. The serial connection body of a solid-state battery constituting such a power generation element, and the parallel connection body of this serial connection body constitute a partial power generation element relative to the aforementioned such power generation element.

It should be noted that, in the present disclosure, between the positive electrode sheet-like collector 5 and negative electrode sheet-like collector 7 generating the electromotive force E shall be counted as one electrode plane (p=1). In addition, the parallel connection of this electrode plane shall be called p-number parallel.

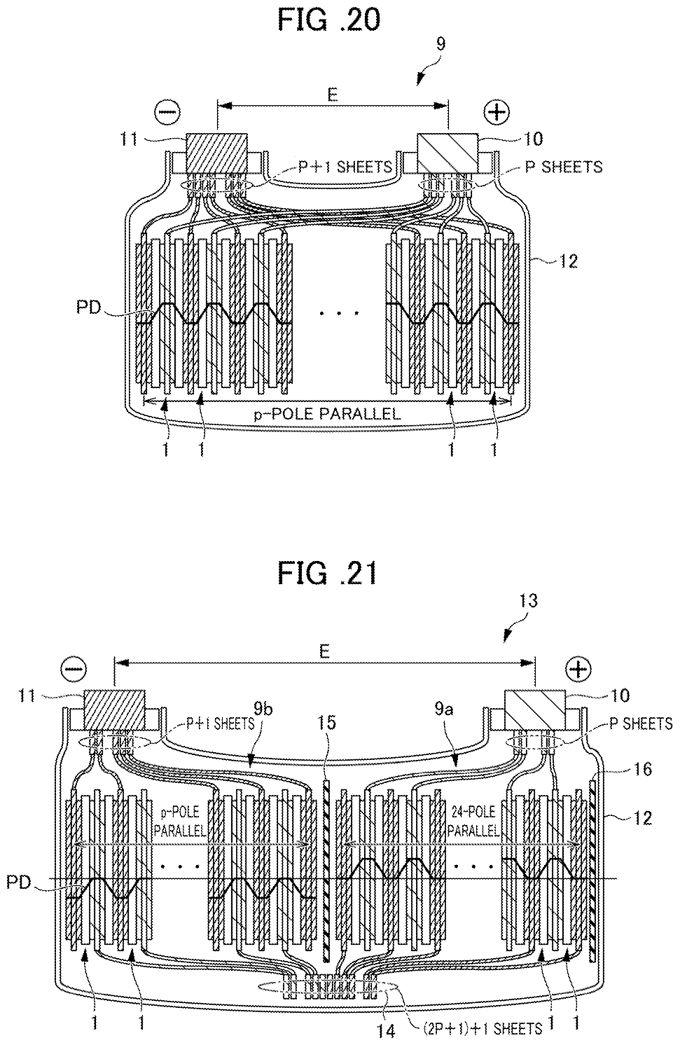

FIG. 20 is a view for explaining the form of wiring to the positive electrode terminal collector electrode plate (positive electrode tab) 10 and negative electrode terminal collector electrode plate (negative electrode tab) 11 in a power generation unit made by connecting a plurality of the solid-state battery of FIG. 19 in parallel. In the power generation unit 9 of FIG. 20, P-number of solid-state batteries 1 are electrically connected in parallel between the positive electrode tab 10 and negative electrode tab 11 for supplying output power to outside. This connection state is noted as p-pole parallel in the drawings. In FIG. 20, the potential difference PD between each solid-state battery 1 is conceptually shown by the bold solid line at an intermediate position in the vertical direction of each solid-state battery 1. Due to being a parallel connection, the electromotive force E produced between the positive electrode tab 10 and negative electrode tab 11 equals the electromotive force of each solid-state battery 1. In addition, due to being a parallel connection, P-number of wires are connected to the positive electrode tab 10, and P+1-number of wires are connected to the negative electrode tab 11, as illustrated. This power generation unit 9 can be conceptualized as a partial power generation unit further constituting a high-voltage power generation unit in multiple layers by serial or parallel connection of the same type of power generation units. It should be noted that the power generation unit 9 is accommodated in the outer packaging 12 which is a laminate.

FIG. 21 is a view for explaining the form of wiring to the positive electrode tab and negative electrode tab, as well as the intermediate potential connection part, in another power generation unit made by connecting in series a plurality of partial power generation units made by connecting in parallel a plurality of the solid-state batteries of FIG. 19. This power generation unit 13 is a unit made by connecting two in series of this partial power generation unit, with a power generation unit of p-pole parallel which is similar to the power generation unit 9 of FIG. 20 as the partial power generation unit. In the present example, p shall be 24. The value for the electromotive force E between the positive electrode tab 10 and negative electrode tab 11 of the power generation unit 13 is twice the electromotive force F of the power generation unit 9 of FIG. 20. The numbers of wires of the positive electrode tab 10 and negative electrode tab 11 are P and P+1, which are the same numbers as the power generation unit 9 of FIG. 20. On the other hand, the number of wires in the midpoint potential connection unit 14 when connecting in series two of the partial power generation units becomes (2P+1)+1. It should be noted that the power generation unit 13 is stored in the outer packaging 12 which is a laminate. An intermediate insulation sheet 15 is interposed between the partial power generation unit 9a on the side of the positive electrode tab 10 and the partial power generation unit 9b on the side of the negative electrode tab 11, and an outer packaging inner surface insulation sheet 16 is interposed between the partial power generation unit 9a and outer packaging 12.

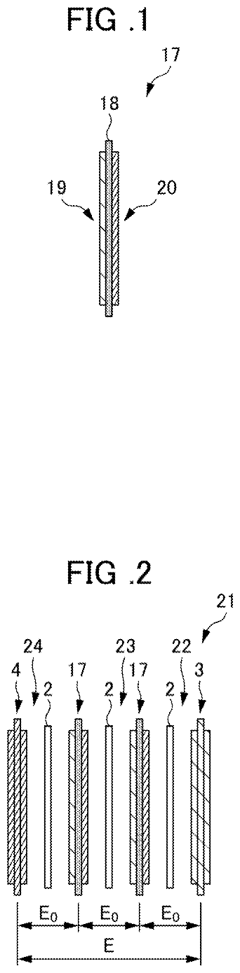

FIG. 1 is a cross-sectional view representing a bipolar electrode applied to the embodiment of the present invention. The bipolar electrode 17 is an electrode in which a positive electrode mixture slurry 19 to become the positive electrode of a polarizable electrode was formed on one surface of one sheet-like collector (current collector foil) 18, and a negative electrode mixture slurry 20 to become a negative electrode of a polarizable electrode was formed on another surface thereof.

FIG. 2 is a theoretical configurational drawing of a secondary battery made using the bipolar electrode of the present invention. In FIG. 2, the secondary battery 21 which is one unit battery is configured as a multi-layer laminate body made by laminating in series a plurality of single laminate bodies. In detail, the positive electrode normal electrode 3 is provided to the outermost end part on the positive electrode side, and the negative electrode normal electrode 4 is provided to the outermost end part on the negative electrode side of the secondary battery 21. In the present example, two bipolar electrodes 17 are provided between the positive electrode normal electrode 3 and the negative electrode normal electrode 4. Solid electrolyte layers 2 are respectively laminated to be sandwiched between the positive electrode normal electrode 3 and one bipolar electrode 17, between the two bipolar electrode 17, and between the other one bipolar electrode 17 and negative electrode normal electrode 4, from the side of the positive electrode normal electrode 3 towards the side of the negative electrode normal electrode 4.

In other words, the partial unit battery 22 of a first form is configured so that one solid electrolyte layer 2 is sandwiched by the positive electrode normal electrode 3 and one bipolar electrode 17. The partial unit battery 23 of a second form is configured so that one solid electrolyte layer 2 is sandwiched by the two bipolar electrodes 17 of one bipolar electrode 17 and another bipolar electrode 17. In addition, a partial unit battery 24 of a third form is configured so that one solid electrolyte layer 2 is sandwiched by the other one bipolar electrode 17 and the negative electrode normal electrode 4.

The electromotive force of each partial unit battery sequentially laminating, from the side of the negative electrode normal electrode 4 towards the side of the positive electrode normal electrode 3, the partial unit battery 24 of the third form, the partial unit battery 23 of the second form and the partial unit battery 22 of the first form are equal at EQ (for example, 3.7 volts). In addition, the partial unit battery 24 of the third form, partial unit battery 23 of the second form and partial unit battery 22 of the first form are laminated in order from the side of the negative electrode normal electrode 4 towards the side of the positive electrode normal electrode 3, and thereby constitute the serial connection body. Therefore, the electromotive force E of the secondary battery (unit battery) 21 becomes EQ×3 (for example, 11.7 volts).

Hereinafter, the partial unit battery 22 of the first form, the partial unit battery 23 of the second form, and the partial unit battery 24 of the third form are collectively called a single laminate body 25 as appropriate. The single laminate 25 is a partial power generation element constituting a power generation element of a secondary battery by itself or as an assembly thereof.

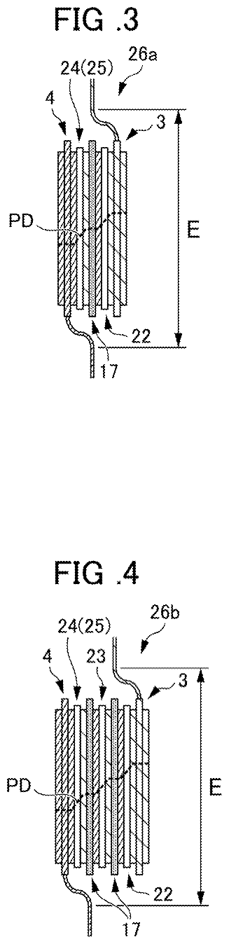

FIGS. 3 to 6 are respectively views showing examples in which the series number of partial unit batteries in the secondary battery (unit battery) 21 are different. In FIGS. 3 to 6, the corresponding parts with the aforementioned FIG. 2 are shown by assigning the same reference symbol. In FIGS. 3 to 6, the potential difference PD between each partial unit battery is conceptually shown by a bold solid line at an intermediate position in the vertical direction of each partial unit battery. In the case of any of FIGS. 3 to 6 as well, the single laminate bodies 25 configuring the multi-layer laminate body are laminated in a direction of polarity configuring the serial connection, between the positive electrode normal electrode 3 and negative electrode normal electrode 4, thereby configuring the serial partial power generation element 26 (26a, 26b, 26c, 26d).

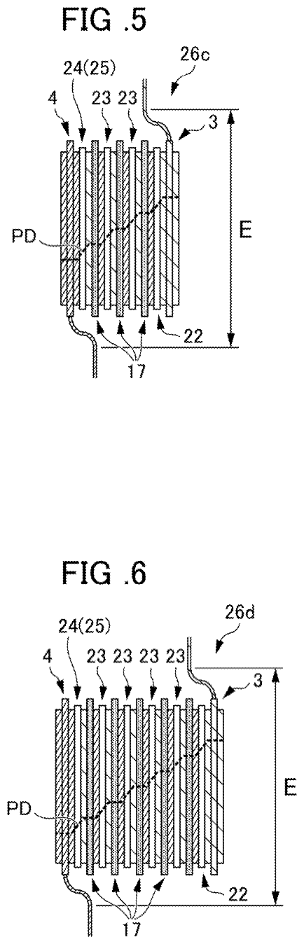

In the case of FIG. 3, a serial partial power generation element 26a which is a laminate body of two layers made by laminating in series two of the single laminates 25 is configured. The occurrence status of the potential difference corresponding to the lamination layer of the single laminate 25 within the serial partial power generation element 26a is shown by the bold line as potential difference PD. In the case of FIG. 4, the serial partial power generation element 26b which is laminate body of three layers made by laminating in series three of the single laminate bodies 25 is configured. The occurrence status of the potential difference corresponding to the lamination layer of the single laminate 25 within the serial partial power generation element 26b is shown by the bold line as potential difference PD. In the case of FIG. 5, the serial partial power generation element 26c which is laminate body of four layers made by laminating in series four of the single laminate bodies 25 is configured. The occurrence status of the potential difference corresponding to the lamination layer of the single laminate 25 within the serial partial power generation element 26c is shown by the bold line as potential difference PD. In the case of FIG. 6, the serial partial power generation element 26d which is laminate body of six layers made by laminating in series six of the single laminate bodies 25 is configured. The occurrence status of the potential difference corresponding to the lamination layer of the single laminate 25 within the serial partial power generation element 26e is shown by the bold line as potential difference PD.

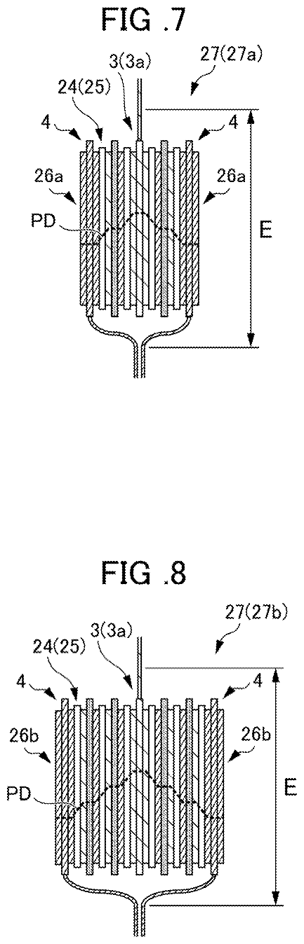

FIGS. 7 to 9 each show a parallel connection body of a first form with one positive electrode normal electrode as the positive electrode collector electrode, in which the serial partial power generation element is joined between the positive collector electrode and two negative electrode normal electrodes corresponding thereto, to have reversed polarity, sandwiching the positive collector electrode, and the serial partial power generation element is connected in parallel between the positive collector electrode and two negative electrode normal electrodes.

In the case of FIG. 7, with one positive electrode normal electrode 3 as the positive collector electrode 3a, the serial partial power generation element 26a of FIG. 3 is connected between the two negative electrode normal electrodes 4, 4 corresponding to the positive collector electrode 3a, with reversed polarity, to sandwich the positive collector electrode 3a. The parallel connection body 27 (27a) of the first form in which the serial partial power generation elements 26a are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27a of the first form is shown by the bold line as potential difference PD.

In the case of FIG. 8, with one positive electrode normal electrode 3 as the positive collector electrode 3a, the serial partial power generation element 26b of FIG. 4 is connected between the two negative electrode normal electrodes 4, 4 corresponding to the positive collector electrode 3a, with reversed polarity, to sandwich the positive collector electrode 3a. The parallel connection body 27 (27b) of the first form in which the serial partial power generation elements 26b are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27b of the first form is shown by the bold line as potential difference PD.

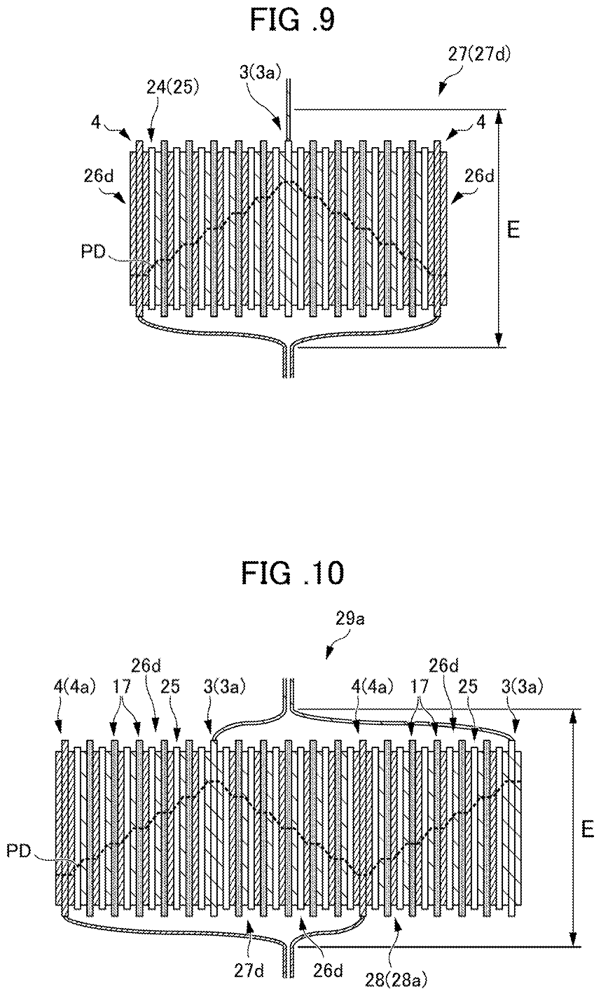

In the case of FIG. 9, with one positive electrode normal electrode 3 as the positive collector electrode 3a, the serial partial power generation element 26d of FIG. 6 is connected between the two negative electrode normal electrodes 4, 4 corresponding to the positive collector electrode 3a, with reversed polarity, to sandwich the positive collector electrode 3a. The parallel connection body 27 (27d) of the first form in which the serial partial power generation elements 26 d are connected in parallel between the positive collector electrode 3a and the two negative electrode normal electrodes 4, 4 is configured by this joining. The occurrence status of the potential difference corresponding to the lamination layers of the single laminate bodies 25 within the parallel connection body 27d of the first form is shown by the bold line as potential difference PD.

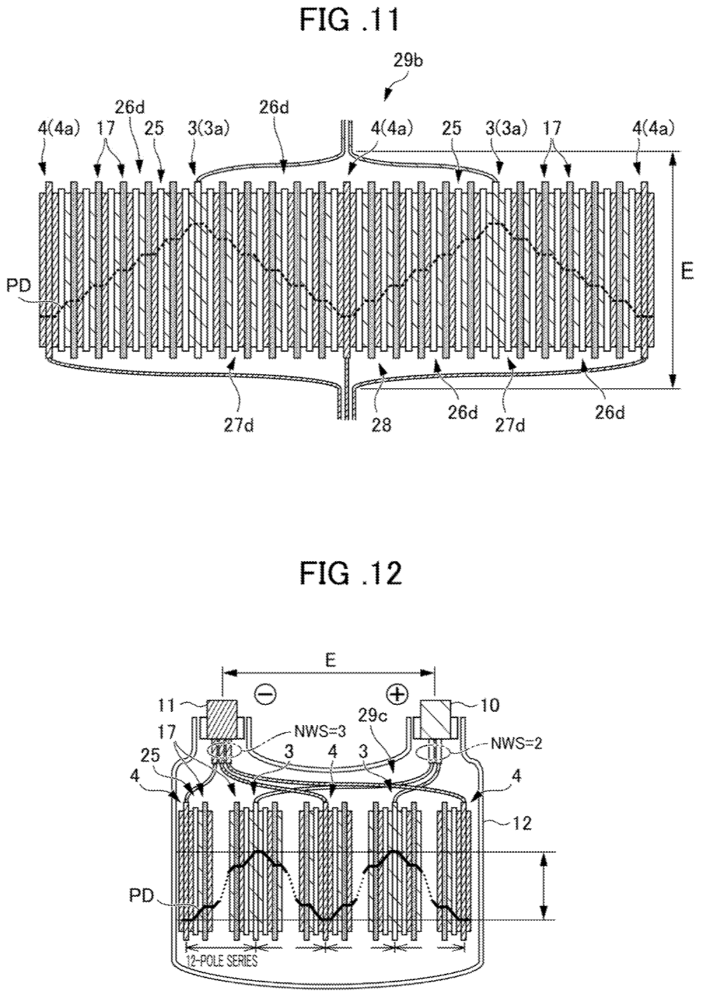

FIGS. 10 and 11 respectively show a parallel connection body made by connecting in parallel the serial partial power generation element 26d of FIG. 6 and the parallel connection body 27d of the first form of FIG. 9. These parallel connection bodies can be seen as being a combination of the aforementioned parallel connection body 27 of the first form, and a parallel connection body 28 of a second form which is a different form than this.

Parallel connection body 28 of the second form is a connection body with one negative electrode normal electrode 4 as the negative collector electrode 4a, in which the serial partial power generation element 26 is joined with reversed polarity sandwiching the negative collector electrode 4a, between the negative collector electrode 4a and two positive electrode normal electrodes 3, 3 corresponding thereto. In other words, the parallel connection body 28 (28a) of the second form is a connection body in which the serial partial power generation element 26 is connected in parallel between the negative collector electrode 4a and two positive electrode normal electrodes 3, 3.

The case of FIG. 10 is a configuration connecting in parallel three laminate bodies of six layers made by laminating in series six single laminate bodies, and can be seen as being a connection body made by connecting in parallel three groups of a six-pole series. In addition, it can be seen as being a composite parallel connection body 29 (29a) made by combining the aforementioned parallel connection body 28a of the second form establishing one negative electrode normal electrode 4 as the negative collector electrode 4a, with the parallel connection body 27d of the first form in FIG. 9. In this case, the composite parallel connection body 29a has in the common the serial partial power generation element 26 between the positive collector electrode 3a or negative collector electrode 4a, and one of the negative common electrode 4 or positive common electrode 3. The occurrence status of the potential difference corresponding to the lamination layer of the single laminate body 25 within the composite parallel connection body 29a is shown by the bold line as potential difference PD.

The case of FIG. 11 is a configuration connecting in parallel four laminate bodies of six layers made by laminating six single laminate bodies in series, and can be seen as being a connection body made by connecting in parallel four groups of six-pole series. In addition, it can be seen as being a composite parallel connection body 29 (29b) made by joining the parallel connection body 27d of the first form in FIG. 9 with one negative electrode normal electrode 4, i.e. negative collector electrode 4a, as a joining part, in reverse polarity to this joining part. In this case as well, the composite parallel connection body 29b has in the common the serial partial power generation element 26 between the positive collector electrode 3a or negative collector electrode 4a, and one of the negative common electrode 4 or positive common electrode 3. The occurrence status of the potential difference corresponding to the lamination layer of the single laminate body 25 within the composite parallel connection body 29b is shown by the bold line as potential difference PD.

FIGS. 12 to 14 are each diagrams for explaining the configuration further connecting in parallel a plurality of laminate bodies made by laminating in series a plurality of single laminate bodies and the occurrence status of the potential difference between both positive and negative electrodes for each of the plurality of laminate bodies, as well as the form of wiring to the positive electrode terminal collector electrode plate and negative electrode terminal collector electrode plate.

FIG. 12 is a configuration connecting in parallel four laminate bodies of twelve layers mad by laminating in series twelve of the single laminate bodies, and can be seen as being a composite parallel connection body 29 (29c) made by connecting in parallel four groups of twelve-pole series. The occurrence status of the potential difference corresponding to the lamination layer of the single laminate bodies 25 within the composite parallel connection body 29c is shown by the bold line as potential difference PD. The form of wiring to the positive electrode 10 connected with each positive electrode terminal collector electrode plate and the form of wiring to the negative electrode tab 11 connected with each negative electrode terminal collector electrode plate are shown as the number of welded sheets (abbreviated as NWS) of wiring. The output electromotive force E is obtained between the positive electrode tab 10 and negative electrode tab 11. In the case of the twelve-pole series of FIG. 12 being a four-group parallel connection, NWS is 2 at the positive electrode tab 10, and NWS is 3 at the negative electrode tab 11. It should be noted that the composite parallel connection body 29c is stored in the outer packaging 12 which is a laminate.

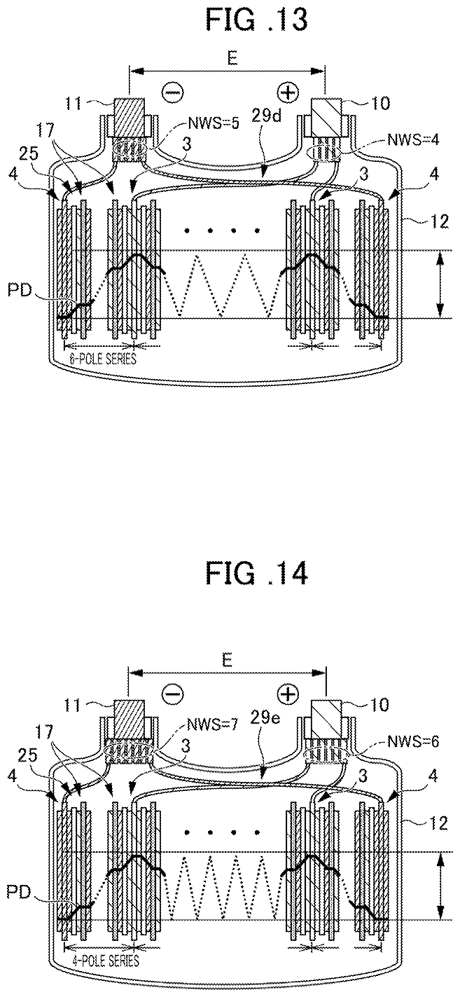

FIG. 13 is a configuration which connects in parallel eight of the laminate bodies of six layers made by laminating six single laminate bodies in series, and can be seen as being the composite parallel connection body 29 (29d) made by connecting eight groups in parallel of six-pole series. The occurrence status of the potential difference corresponding to the lamination layer of the single laminate bodies 25 within the composite parallel connection body 29d is shown by the bold line as potential difference PD. The form of wiring to the positive electrode 10 connected with each positive electrode terminal collector electrode plate and the form of wiring to the negative electrode tab 11 connected with each negative electrode terminal collector electrode plate are shown as the number of welded sheets (abbreviated as NWS) of wiring. The output electromotive force E is obtained between the positive electrode tab 10 and negative electrode tab 11. In the case of the six-pole series of FIG. 13 being a four-group parallel connection, NWS is 4 in the positive electrode tab 10, and NWS is 5 in the negative electrode tab 11. It should be noted that the composite parallel connection body 29d is stored in the outer packaging 12 which is a laminate.

FIG. 14 is a configuration which connects in parallel twelve of the laminate bodies of four layers made by laminating four single laminate bodies in series, and can be seen as being the composite parallel connection body 29 (29e) made by connecting twelve groups in parallel of four-pole series. The occurrence status of the potential difference corresponding to the lamination layer of the single laminate bodies 25 within the composite parallel connection body 29e is shown by the bold line as potential difference PD. The form of wiring to the positive electrode 10 connected with each positive electrode terminal collector electrode plate and the form of wiring to the negative electrode tab 11 connected with each negative electrode terminal collector electrode plate are shown as the number of welded sheets (abbreviated as NWS) of wiring. The output electromotive force E is obtained between the positive electrode tab 10 and negative electrode tab 11. In the case of four-pole series of FIG. 14 being a twelve-group parallel connection, NWS is 6 in the positive electrode tab 10, and NWS is 7 in the negative electrode tab 11. It should be noted that the composite parallel connection body 29e is stored in the outer packaging 12 which is a laminate.

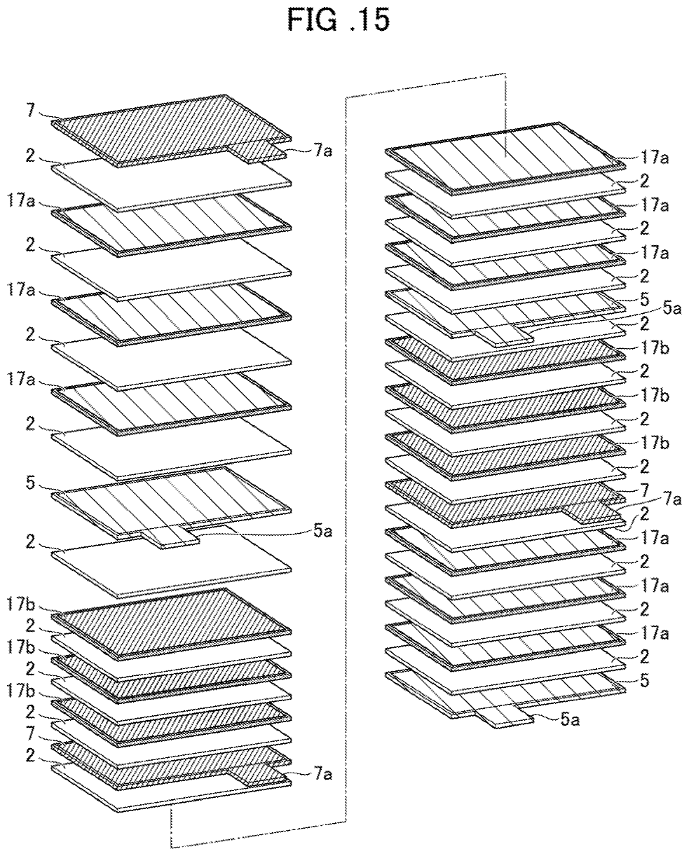

FIG. 15 is an exploded conceptual diagram for explaining the physical configuration of a laminate body of a plurality of layers made by laminating a plurality of single laminate bodies in series. In the example of the illustration, the negative electrode sheet-like collector 7 having the negative electrode 7a is positioned at the topmost layer. The negative electrode sheet-like collector 7 is one form of the negative electrode normal electrode 4.

, the single laminate body (partial power generation element) composed of the solid electrolyte layer 2, bipolar electrode 17a of the first form and the solid electrolyte layer 2 is repeatedly laminated as in the illustration sequentially towards the bottom layer from the negative electrode sheet-like collector 7.

The bipolar electrode 17a of the first form is a bipolar electrode of a form in which the positive electrode material (positive electrode mixture slurry 19) is coated on the upper layer surface side in the lamination direction of the single laminate body of FIG. 15, and the negative electrode material (negative electrode mixture slurry 20) is coated on the lower layer surface side.

The positive electrode sheet-like collector 5 having the positive electrode 5a is laminated at a place where repetition ends of lamination layers of single laminate body (partial power generation element) composed of the bipolar electrode 17a of the first form and the solid electrolyte layer 2. The single laminate (partial power generation element) composed by the bipolar electrode 17b of the second form and the solid electrolyte layer 2 are repeatedly laminated as in the illustrations, from the positive electrode sheet-like collector 5 further towards sequential lower layers.

The bipolar electrode 17b of the second form is a bipolar electrode of a form in which the negative electrode material (negative electrode mixture slurry 20) is coated on the upper layer surface side in the lamination direction of the single laminate body in FIG. 15, and the positive electrode material (positive electrode mixture slurry 19) is coated on the lower layer surface side.

The negative electrode sheet-like collector 7 having the negative electrode 7a is laminated at a place where repetition ends of lamination of the single laminate body (partial power generation element) composed of the bipolar electrode 17b of the second form and the solid electrolyte layer 2. Lamination is repeated as mentioned above from the negative electrode sheet-like collector 7 having the negative electrode 7a laminated again, further towards the sequential lower layers, as illustrated, and the positive electrode sheet-like collector 5 having the positive electrode 5a is laminated on the bottom most layer.

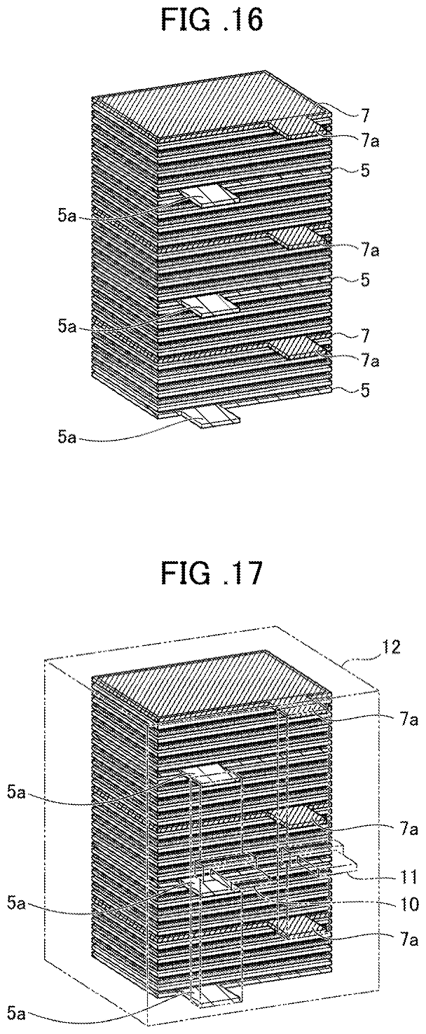

FIG. 16 is a conceptual diagram representing the form after lamination of the laminate body of FIG. 15. As illustrated, the positive electrode 5a of each positive electrode sheet-like collector 5 overlaps at a projection position of the laminate body in the lamination direction. Similarly, the negative electrode 7a of each negative electrode sheet-like collector 7 overlaps at the projection position of the laminate body in the lamination direction.

FIG. 17 is a view showing a battery pack made by storing the laminate body of FIG. 16 in the outer packaging. In the battery pack of FIG. 17, the positive electrodes 5a of each positive electrode sheet-like collector 5 which is at a position overlapping at the projection position of the laminate bodies in the lamination direction as in FIG. 16 are connected in parallel by cell-internal collector conductor which is illustrated with virtual lines, then collected at the positive electrode tab 10, and led outside of the outer packaging 12. Similarly, the negative electrodes 7a of each negative electrode sheet-like collector 7 which is at a position overlapping in the projection position of the laminate body in the lamination direction are connected in parallel by a cell-internal collector conductor which is illustrated with virtual lines, then collected at the negative electrode tab 11, and led outside of the outer packaging 12.

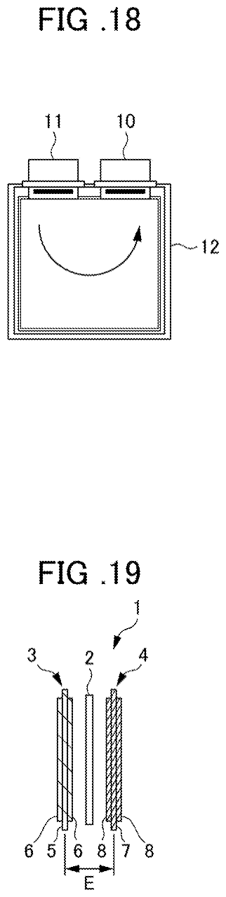

FIG. 18 is a projection view in the lamination direction of laminate bodies of the battery pack in FIG. 17. As illustrated, the positive electrode tab 10 and negative electrode tab 11 are led in parallel to outside from the same lateral surface of the rectangular outer packaging 12. The arrow in FIG. 18 conceptually represents the direction of the electrical current.

According to the secondary battery made using the bipolar electrode of the present embodiment, the following effects are exerted.

(1) The secondary battery made using the bipolar electrode includes:

a partial power generation element 25 which is configured by a single laminate body, in which the bipolar electrode 17 having the positive electrode mixture slurry 19 coated on one surface and the negative electrode mixture slurry 20 coated on the other surface of the sheet-like collector (current collector foil) 18, is laminated on at least one surface side of the solid electrolyte layer 2, or is configured by a multi-layer laminate body in which a plurality of the single laminate bodies is laminated; and
the positive electrode normal electrode 3, negative electrode normal electrode 4 of a form laminated directly or via the solid electrolyte layer 2 on the one surface side and the other surface side of the partial power generation element 25, and in which poles of the same polarity are formed on both surfaces of one sheet-like collector (current collector foil) 18. With this configuration, the positive electrode normal electrode 3, and negative electrode normal electrode 4 are positioned at sites drawing out the battery output to the outside, which is one surface side and the other surface side of the partial power generation element 25. For this reason, for the connection of the conductor drawing out the battery output to outside, specific technology such that is compatible with bipolar electrodes is not necessitated, and production for enabling adoption of conventional welding technology is easy.

(2) With the secondary battery 1 made using the bipolar electrode, the normal electrode is either the positive electrode normal electrode 3 laminated on one surface side of the partial power generation element 25, or the negative electrode normal electrode 4 laminated on the other surface side of the partial power generation element 25. For this reason, for either of the one surface side and other surface side of the partial power generation element 25, special technology using a clad material such that is compatible with the bipolar electrode is not necessitated for connection of the conductor drawing out the battery output to outside, and thus production for enabling adoption of conventional welding technology is easy.

(3) With the secondary battery 1 made using the bipolar electrode, the partial power generation elements configure a serial partial power generation element 26, 26a, 26b, 26c, 26d in which the single laminate body 25 configuring the multi-layer laminate body is laminated in a direction of polarity configuring a serial connection, between the positive electrode normal electrode 3 and the negative electrode normal electrode 4. For this reason, it is possible to configure serial connection body by laminating so as to directly contact the partial unit battery 22 of the first form, partial unit battery 23 of the second form and partial unit battery 24 of the third form without going through other conductors, and possible to take full advantage of bipolar electrode for which the internal resistance decreases.

(4) With the secondary battery 1 made using the bipolar electrode, the secondary battery configures a parallel connection body of a first form 27, 27a, 27b, 27d in which the serial partial power generation element is joined, with one of the positive electrode normal electrodes 3 as a positive electrode collector 5 which is a positive electrode collector electrode 5, between the positive electrode sheet-like collector 5 and two of the negative electrode normal electrodes 4, 4 corresponding thereto, to sandwich the positive electrode sheet-like collector 5 with reversed polarity, and the serial partial power generation element is connected in parallel between the positive electrode collector electrode and two of the negative electrode normal electrodes 4, 4. For this reason, since the conductor on the positive electrode side for connecting in parallel both serial partial power generation elements is necessitated for each serial partial power generation element, with this configuration, one positive electrode sheet-like conductor 5 comes to function as a shared conductor for both serial partial power generation elements. Therefore, there less conductors on the positive electrode side for parallel connecting, and the configuration is simplified.

(5) With the secondary battery 1 made using the bipolar electrode, the secondary battery configures a parallel connection body of a second form 28 in which the serial partial power generation element is joined, with one of the negative electrode normal electrodes 4 as a negative electrode sheet-like collector 7 which is a negative electrode collector electrode, between the negative electrode sheet-like collector 7 and two of the positive electrode normal electrodes 3, 3 corresponding thereto, to sandwich the negative electrode sheet-like collector 7 with reversed polarity, and the serial partial power generation element is connected in parallel between the negative electrode sheet-like collector 7 and two of the positive electrode normal electrodes 3, 3. For this reason, since the conductor on the negative electrode side for connecting in parallel both serial partial power generation elements is necessitated for each serial partial power generation element, with this configuration, one negative electrode sheet-like conductor 7 comes to function as a shared conductor for both serial partial power generation elements. Therefore, there are less conductors on the negative electrode side for parallel connecting, and the configuration is simplified.

(6) With the secondary battery 1 made using the bipolar electrode, a parallel connection body of a first form 27, 2⁷a, 27b, 27d in which the serial partial power generation element is joined, with one of the positive electrode normal electrodes 3 as a positive electrode collector 5 which is a positive electrode collector electrode 5, between the positive electrode sheet-like collector 5 and two of the negative electrode normal electrodes 4, 4 corresponding thereto, to sandwich the positive electrode sheet-like collector 5 with reversed polarity, and the serial partial power generation element is connected in parallel between the positive electrode collector electrode and two of the negative electrode normal electrodes 4, 4, and

a parallel connection body of a second form 28 in which the serial partial power generation element is joined, with one of the negative electrode normal electrodes 4 as a negative electrode sheet-like collector 7 which is a negative electrode collector electrode, between the negative electrode sheet-like collector 7 and two of the positive electrode normal electrodes 3, 3 corresponding thereto, to sandwich the negative electrode sheet-like collector 7 with reversed polarity, and the serial partial power generation element is connected in parallel between the negative electrode sheet-like collector 7 and two of the positive electrode normal electrodes 3, 3, configure
a composite parallel connection body 29, 29a, 29b, 29c, 29d, 29e by sharing the serial partial power generation element between the positive electrode sheet-like collector 5 or the negative electrode sheet-like collector 7, and one of the negative electrode normal electrode 4 or the positive electrode normal electrode 3. For this reason, as explained in the above (4) and (5), there are less conductors on the positive electrode side and negative electrode side for parallel connecting, and the configuration is simplified.

(7) With the secondary battery 1 made using the bipolar electrode, the composite parallel connection body has the negative electrode normal electrode 4, 4 located at both outermost ends in a connection direction thereof. For this reason, even without interposing a separate insulating body between outer packaging 12, since the potential at the site at which the composite parallel connection body contacts the inner surface of the outer packaging 12 is the same potential at the negative electrode potential, the safety is secured. It should be noted that this configuration is realized in the case of the parallel number of the composite parallel connection body being an even.

(8) With the secondary battery 1 made using the bipolar electrode, the composite parallel connection body has the positive electrode normal electrode 4, 4 located at both outermost ends in a connection direction thereof. For this reason, even without interposing a separate insulating body between outer packaging 12, since the potential at the site at which the composite parallel connection body contacts the inner surface of the outer packaging 12 is the same potential at the positive electrode potential, the safety is secured. It should be noted that this configuration is realized in the case of the parallel number of the composite parallel connection body being an even.

(9) With the secondary battery 1 made using the bipolar electrode, the composite parallel connection body provides a connection conductor to each of the positive electrode sheet-like collector 5 and negative electrode sheet-like collector 7, and provides a positive electrode tab 10 and a negative electrode tab 11 for supplying output power to outside collectively to each of the connection conductors of positive polarity and negative polarity. For this reason, a battery pack which is compact overall and having good usability is provided.

(10) The secondary battery 1 made using the bipolar electrode further includes an outer packaging 12 of laminate material enveloping the composite parallel connection body and the connection conductors of positive polarity and negative polarity, in which a part of the positive electrode tab 10 and the negative electrode tab 11 are led to outside from the outer packaging 12. For this reason, a compact battery pack suited to a configuration as an all solid-state battery is provided.

Although embodiments of the present invention have been explained above, the present invention is not to be limited thereto. The configuration of detailed parts may be modified as appropriate within a scope of the gist of the present invention. For example, the structure equipped with the mechanism causing the pressing force which presses the battery in the lamination direction to act may be adopted as the outer packaging.

### EXPLANATION OF REFERENCE NUMERALS

1 solid-state battery
2 solid electrolyte layer
3 positive electrode normal electrode
3a positive electrode collector electrode
4 negative electrode normal electrode
4a negative electrode collector electrode
5 positive electrode sheet-like collector
5a positive electrode
6 positive electrode mixture
7 negative electrode sheet-like collector
7a negative electrode
8 negative electrode mixture
9 power generation unit
10 positive electrode tab
11 negative electrode tab
12 outer packaging
13 (other) power generation unit
14 midpoint potential connection part
15 intermediate insulation sheet
16 outer packaging inner surface insulation sheet.
17 bipolar electrode
18 sheet-like collector (current collector foil)
19 positive electrode mixture slurry
20 negative electrode mixture slurry
21 secondary battery (unit battery)
22 partial unit battery of first form
23 partial unit battery of second form
24 partial unit battery of third form
25 single laminate body (partial power generation element)
26 (26a, 26b, 26c, 26d) serial partial power generation element
27 (27a, 27b, 27d) parallel connection body of first form
28 parallel connection body of second form
29 (29a, 29b, 29c, 29d, 29e) composite parallel connection body

What is claimed is:

1. A secondary battery comprising a bipolar electrode including:
a partial power generation element which is configured by a single laminate body, in which bipolar electrode having a positive electrode of a polarizable electrode formed on one surface and a negative electrode of the polarizable electrode formed on the other surface of one sheet-like collector, is laminated on at least one surface side of a solid electrolyte layer, or is configured by a multi-layer laminate body in which a plurality of the single laminate bodies is laminated; and
a normal electrode of a form laminated directly or via the solid electrolyte layer on the one surface side and the other surface side of the partial power generation element, and in which poles of the same polarity are formed on both surfaces of one sheet-like collector.

2. The secondary battery comprising the bipolar electrode according to claim 1,
wherein the normal electrode is either a positive electrode normal electrode of a form laminated on one surface side of the partial power generation element and having a pole of positive polarity formed on both surfaces of one sheet-like collector, or a negative electrode normal electrode laminated on the other surface side of the partial power generation element and having a pole of negative polarity formed on both surfaces of the one sheet-like collector.

3. The secondary battery comprising the bipolar electrode according to claim 2,
wherein the partial power generation element configures a serial partial power generation element in which a single laminate body configuring the multi-layer laminate body is laminated in a direction of polarity configuring a serial connection, between the positive electrode normal electrode and the negative electrode normal electrode.

4. The secondary battery comprising the bipolar electrode according to claim 3,
wherein the secondary battery configures a parallel connection body of a first form in which the serial partial power generation element is joined, with one of the positive electrode normal electrodes as a positive electrode collector electrode, between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrodes.

5. The secondary battery comprising the bipolar electrode according to claim 3,
wherein the secondary battery configures a parallel connection body of a second form in which the serial partial power generation element is joined, with one of the negative electrode normal electrodes as a negative electrode collector electrode, between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrodes.

6. The secondary battery comprising the bipolar electrode according to claim 3,
wherein a parallel connection body of a first form in which the serial partial power generation element is joined, with one of the positive electrode normal electrodes as a positive electrode collector electrode, between the positive electrode collector electrode and two of the negative electrode normal electrodes corresponding thereto, to sandwich the positive electrode collector electrode with reversed polarity, and the serial partial power generation element is connected in parallel between the positive electrode collector electrode and two of the negative electrode normal electrode, and
a parallel connection body of a second form in which the serial partial power generation element is joined, with one of the negative electrode normal electrodes as a negative electrode collector electrode, between the negative electrode collector electrode and two of the positive electrode normal electrodes corresponding thereto, to sandwich the negative electrode collector electrode with reversed polarity, and the serial partial power generation element is connected in parallel between the negative electrode collector electrode and two of the positive electrode normal electrode, configure a composite parallel connection body by sharing the serial partial power generation element between the positive electrode collector electrode or the negative electrode collector electrode, and one of the negative electrode normal electrode or the positive electrode normal electrode.

7. The secondary battery comprising the bipolar electrode according to claim 6,
wherein the composite parallel connection body has the negative electrode normal electrode located at both outermost ends in a connection direction thereof.

8. The secondary battery comprising the bipolar electrode according to claim 6,
wherein the composite parallel connection body has the positive electrode normal electrode located at both outermost ends in a connection direction thereof.

9. The secondary battery comprising the bipolar electrode according to claim 6,
wherein the composite parallel connection body provides a connection conductor to each of the positive collector electrode and the negative collector electrode, and provides a positive electrode tab and a negative electrode tab for supplying output power to outside collectively to each of the connection conductors of positive polarity and negative polarity.

10. The secondary battery comprising the bipolar electrode according to claim 9, further comprising
an outer packaging of laminate material enveloping the composite parallel connection body and the connection conductors of positive polarity and negative polarity, wherein a part of the positive electrode tab and the negative electrode tab are led to outside from the outer packaging.

11. The secondary battery comprising the bipolar electrode according to claim 7,
wherein the composite parallel connection body provides a connection conductor to each of the positive collector electrode and the negative collector electrode, and provides a positive electrode tab and a negative electrode tab for supplying output power to outside collectively to each of the connection conductors of positive polarity and negative polarity.

12. The secondary battery comprising the bipolar electrode according to claim 8,
wherein the composite parallel connection body provides a connection conductor to each of the positive collector electrode and the negative collector electrode, and provides a positive electrode tab and a negative electrode tab for supplying output power to outside collectively to each of the connection conductors of positive polarity and negative polarity.

13. The secondary battery comprising the bipolar electrode according to claim 11, further comprising
an outer packaging of laminate material enveloping the composite parallel connection body and the connection conductors of positive polarity and negative polarity, wherein a part of the positive electrode tab and the negative electrode tab are led to outside from the outer packaging.

14. The secondary battery comprising the bipolar electrode according to claim 12, further comprising
an outer packaging of laminate material enveloping the composite parallel connection body and the connection conductors of positive polarity and negative polarity, wherein a part of the positive electrode tab and the negative electrode tab are led to outside from the outer packaging.
